(19) United States
(12) Patent Application Publication
(10) Pub. No.: US 2012/0225327 A1
(43) Pub. Date: Sep. 6, 2012

(54) BATTERY WITH EMBEDDED DETECTING UNITS

(76) Inventors: Shanming MA, Shenzhen (CN); Min WANG, Shanghai (CN); Wei ZHANG, Shanghai (CN); Wenbo ZHANG, Shanghai (CN); Shaolan WANG, Beijing (CN)

(21) Appl. No.: 13/225,024

(22) Filed: Sep. 2, 2011

(30) Foreign Application Priority Data
Jan. 20, 2011 (CN) 201110026704.2
Mar. 9, 2011 (CN) 201110059124.3

(51) Int. Cl. H01M 10/48; H01M 10/04; H01M 2/00

(52) U.S. Cl. 429/7; 429/90; 29/623.1

(57) ABSTRACT

A battery includes multiple battery cells separated by isolating plates, and multiple detecting units coupled to the battery cells and operable for detecting a status of the battery cells. The battery further includes multiple interfaces coupled to the detecting units and operable for receiving detecting results indicating the status from the detecting units. After the battery is airproofed, the battery cells and the detecting units are enveloped inside the battery.

### RELATED APPLICATIONS

The present application claims priority to Patent Application No. 201110059124.3, filed on Mar. 9, 2011, and Patent Application No. 201110026704.2, filed on Jan. 20, 2011, with the State Intellectual Property Office of the People's Republic of China, both of which are hereby incorporated by reference in their entirety.

### BACKGROUND

Generally, batteries are widely used to provide power to electronic devices. FIG. 1 illustrates a conventional battery. As shown in FIG. 1, a battery 102 includes multiple battery cells 104_1-104_5 separated by isolating plates. A positive terminal and a negative terminal of the battery 102 protrude on the outside of the battery 102 after the battery 102 is airproofed. The status of the battery 102 can be detected via the positive and negative terminals of the battery 102. However, a user may want to detect the status of the inner battery cells 104_1-104_5. Since the battery 102 is airproofed and only the positive and negative terminals protrude on the outside of the battery 102, the user may need to drill holes into the battery 102 at target positions in order to connect external detecting units to the inner battery cells. There are a number of drawbacks associated with such an approach.

Firstly, impurities may be introduced into the battery 102 via the holes, which may affect performance of the battery 102. Secondly, the detecting units may not be stably connected with the inner battery cells. Thus, the detecting units may not remain connected to the inner battery cells.

Thirdly, since electrolyte liquid exists in the battery cells 104_1-104_5, if the user does not drill holes at exactly the right positions, a hole might be accidentally drilled into a battery cell, allowing the electrolyte liquid to leak out and damaging the battery.

Furthermore, attaching external detecting units to a battery will change the shape or size of the battery. Consequently, the battery may no longer fit into certain products, or products may need to be modified in some way in order to accommodate the detecting units.

### SUMMARY

In one embodiment, a battery includes multiple battery cells separated by isolating plates, and includes multiple detecting units coupled to the battery cells and operable for detecting a status of the battery cells. The battery further includes multiple interfaces coupled to the detecting units and operable for receiving detecting results indicating the status from the detecting units. After the battery is airproofed, the battery cells and the detecting units are enveloped inside the battery.

In another embodiment, a method for fabricating a battery includes separating multiple battery cells using isolating plates in the battery, embedding multiple detecting units in the battery to detect a status of the battery cells, outputting detecting results indicating the status from the detecting units via multiple interfaces coupled to the detecting units, and airproofing the battery to envelop the battery cells and the detecting units inside the battery.

In yet another embodiment, a battery system includes multiple battery cells separated by isolating plates, and includes multiple detecting units coupled to the battery cells and operable for detecting a status of the battery cells. The battery system further includes a battery management unit coupled to the detecting units and operable for receiving detecting results indicating the status of the battery cells from the detecting units, and operable for performing predefined operations according to the detecting results. The battery management unit communicates with an outside device via multiple interfaces. After the battery is airproofed, the battery cells, the detecting units, and the battery management unit are enveloped inside the battery.

### BRIEF DESCRIPTION OF THE DRAWINGS

Features and advantages of embodiments of the subject matter will become apparent as the following detailed description proceeds, and upon reference to the drawings, wherein like numerals depict like parts, and in which:

FIG. 1 illustrates a conventional battery.

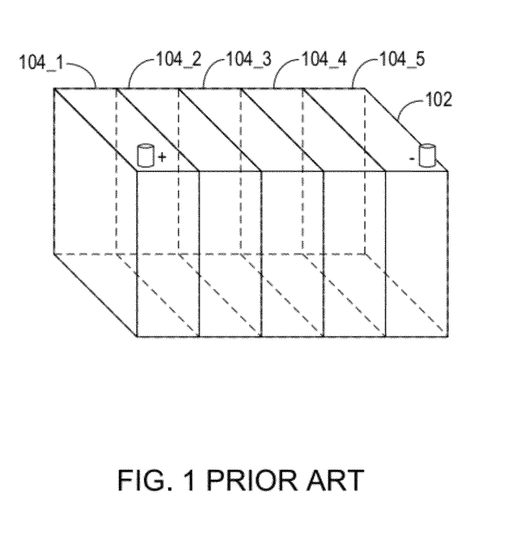

FIG. 2A illustrates an external view of a battery with embedded detecting units, in accordance with one embodiment of the present invention.

FIG. 2B illustrates an external view of a battery with embedded detecting units, in accordance with another embodiment of the present invention.

FIG. 2C illustrates an external view of a battery with embedded detecting units, in accordance with another embodiment of the present invention.

FIG. 2D illustrates an external view of a battery with embedded detecting units, in accordance with another embodiment of the present invention.

FIG. 3A illustrates an internal structure of a battery with embedded detecting units, in accordance with one embodiment of the present invention.

FIG. 3B illustrates operations for embedding a detecting unit into a battery, in accordance with one embodiment of the present invention.

FIG. 3C illustrates an internal structure of a battery with embedded detecting units, in accordance with another embodiment of the present invention.

FIG. 3D illustrates an internal structure of a battery with embedded detecting units, in accordance with another embodiment of the present invention.

FIG. 3E illustrates operations for embedding a detecting unit into a battery, in accordance with another embodiment of the present invention.

FIG. 3F illustrates an internal structure of a battery with embedded detecting units, in accordance with another embodiment of the present invention.

FIG. 3G illustrates an internal structure of a battery with embedded detecting units, in accordance with one embodiment of the present invention.

FIG. 3H illustrates operations for embedding a detecting unit into a battery, in accordance with another embodiment of the present invention.

FIG. 4A illustrates an ichnography of a circuitry board, in accordance with one embodiment of the present invention.

FIG. 4B illustrates a tridimensional graph of the circuitry board in FIG. 4A, in accordance with one embodiment of the present invention.

FIG. 4C illustrates an ichnography of a circuitry board, in accordance with another embodiment of the present invention.

FIG. 4D illustrates a tridimensional graph of the circuitry board in FIG. 4C, in accordance with another embodiment of the present invention.

FIG. 4E illustrates an ichnography of a circuitry board, in accordance with another embodiment of the present invention.

FIG. 4F illustrates an ichnography of a circuitry board, in accordance with another embodiment of the present invention.

FIG. 4G illustrates an ichnography of a circuitry board, in accordance with another embodiment of the present invention.

FIG. 5A shows a diagram of a circuitry board mounted on a battery, in accordance with one embodiment of the present invention.

FIG. 5B shows a diagram of a circuitry board mounted on a battery, in accordance with another embodiment of the present invention.

FIG. 6A illustrates a diagram of circuitry on a circuitry board, in accordance with one embodiment of the present invention.

FIG. 6B illustrates a diagram of circuitry on a circuitry board, in accordance with another embodiment of the present invention.

FIG. 6C illustrates a diagram of circuitry on a circuitry board, in accordance with another embodiment of the present invention.

FIG. 6D illustrates a diagram of circuitry on a circuitry board, in accordance with another embodiment of the present invention.

FIG. 7 illustrates a diagram of circuitry on a circuitry board, in accordance with another embodiment of the present invention.

FIG. 8A illustrates a block diagram of an application system including a battery with embedded detecting units, in accordance with one embodiment of the present invention.

FIG. 8B illustrates a block diagram of an application system including a battery with embedded detecting units, in accordance with another embodiment of the present invention.

FIG. 9 illustrates a flowchart of a method for fabricating a battery with embedded detecting units, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide a battery with embedded detecting units. The battery includes multiple battery cells separated by isolating plates and coupled in series by electric bars. Multiple detecting units are coupled to the battery cells to detect the status of the battery cells. After the battery is airproofed, the detecting units are enveloped (embedded) in the battery, and results from the detecting units can be output via multiple interfaces configured outside the battery. Advantageously, a user has no need to drill holes in the battery to detect the status of the inner battery cells. As such, the integrity of the battery is maintained and the introduction of impurities into the battery is avoided.

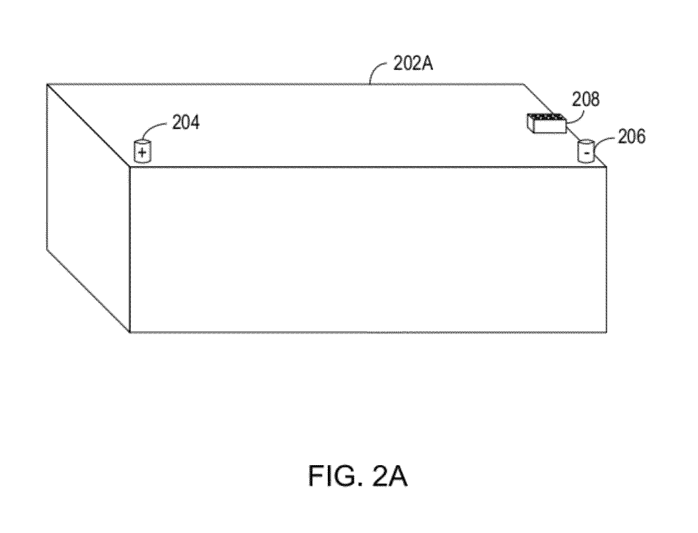

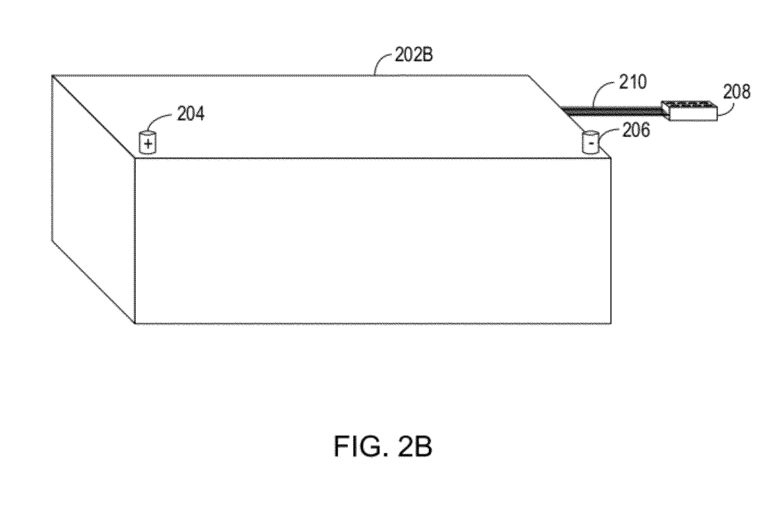

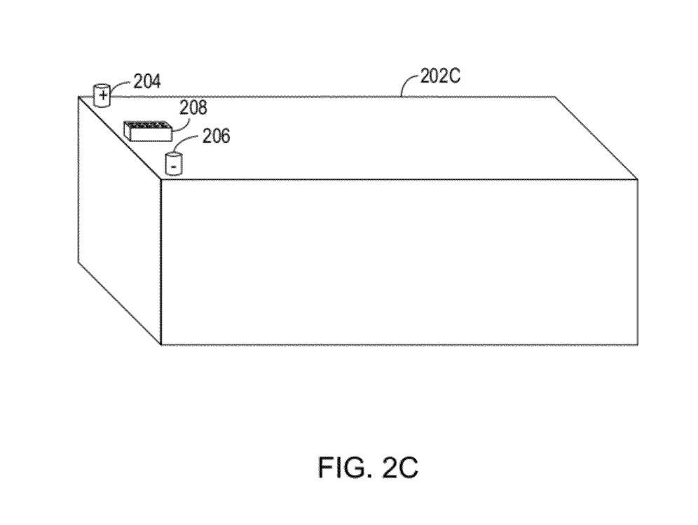

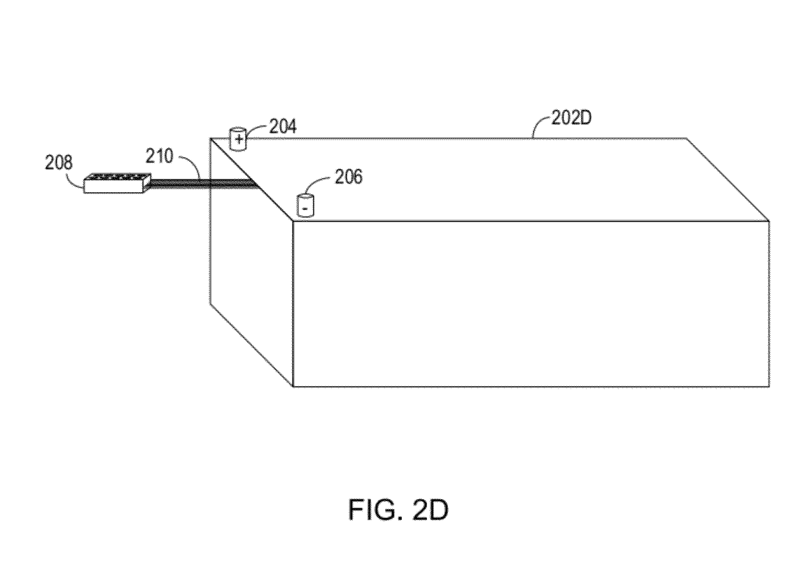

FIG. 2A illustrates an external view of battery 202A with embedded detecting units, in accordance with embodiments of the present invention. The battery 202A includes multiple battery cells (not shown in FIG. 2A) separated by isolating plates. After the battery 202A is airproofed, multiple interfaces, e.g., multiple pins of a connector 208, together with positive and negative terminals 204 and 206 of the battery 202A, are located on the surface of the battery 202A. In one embodiment, the connector 208, the positive terminal 204 and the negative terminal 206 are located on the top panel of the battery 202A. However, the invention is not so limited. The positions of the connector 208, the positive terminal 204 and the negative terminal 206 can be arranged so that they correspond to the inner battery cells.

In one embodiment, multiple detecting units are embedded inside the housing of the battery 202A to detect the status of the inner battery cells. The pins of the connector 208 are connected to the embedded detecting units; each pin is connected to a respective detecting unit. Circuitry for connecting the pins with the embedded detecting units is arranged in the battery 202A before the battery 202A is airproofed, and is thus enveloped in the battery 202A after the battery 202A is airproofed. As such, a battery management unit can monitor the status of the inner battery cells via the pins and perform predefined operations according to the status. For example, the battery management unit performs protecting operations if the battery management unit detects that an abnormal condition is present in the battery cells, e.g., a voltage across an inner battery cell is higher than a predetermined threshold.

Advantageously, the status of the inner battery cells in the battery 202A can be detected by the embedded detecting units and the detecting results can be output via the connector 208 while the battery 202A is in use. Thus, a user does not have to drill holes in the battery 202A in order to attach external detecting units. As such, the integrity of the battery 202A is maintained, and the absence of holes eliminates an avenue through which impurities might enter the battery 202A. Furthermore, because an extra element is not added to the surface of the battery 202A by the user, the size and shape of the battery 202A is unchanged. Thus, the battery 202A can be used in conventional application systems without changing those systems. Consequently, a designer can design a generic mounting fixture that can be used to mount (install) the batteries 202As into various application systems.

Furthermore, the connector 208 also includes pins that are connected to the positive and negative terminals 204 and 206 of the battery 202A. Circuitry for connecting the pins with the positive and negative terminals 204 and 206 is also arranged inside the battery 202A before the battery 202A is airproofed and is thus enveloped inside the battery 202A after the battery 202A is airproofed. As such, the battery management unit can also monitor the status of the battery 202A via the connector 208. Advantageously, extra circuitry for connecting the battery management unit to the positive and negative terminals 204 and 206 can be omitted, which reduces cost and size.

In an alternative embodiment, the connector 208 can be located anywhere outside a battery 202B as shown in FIG. 2B. After the battery 202B is airproofed, a cable 210, in which multiple wires run side-by-side and are bonded, twisted or braided together to form a single assembly, extends from the battery 202B. In the battery 202B, the wires of the cable 210 are separated and connected to the embedded detecting units to transfer data that indicate the status of the inner battery cells. Circuitry for connecting the wires of the cable 210 to the embedded detecting units is arranged in the battery 202B before the battery 202B is airproofed and is thus enveloped inside the battery 202B after the battery 202B is airproofed. The connector 208 can be coupled to an end of the cable 210 outside the battery 202B.

Furthermore, in the battery 202B, wires in the cable 210 are connected to the positive and negative terminals 204 and 206 to transfer data indicating the status of the battery 202B. As such, the connector 208 can also receive that data and output the data via corresponding pins.

Advantageously, the connector 208 can be positioned with greater flexibility and need not be attached to the surface of the battery 202B. Furthermore, the shape of the battery 202B can be simpler, which may simplify the design of the mounting fixture used to mount the battery 202B into an application system.

In yet other embodiments, the connector 208, the positive terminal 204, and the negative terminal 206 are located in the positions shown in FIG. 2C and FIG. 2D.

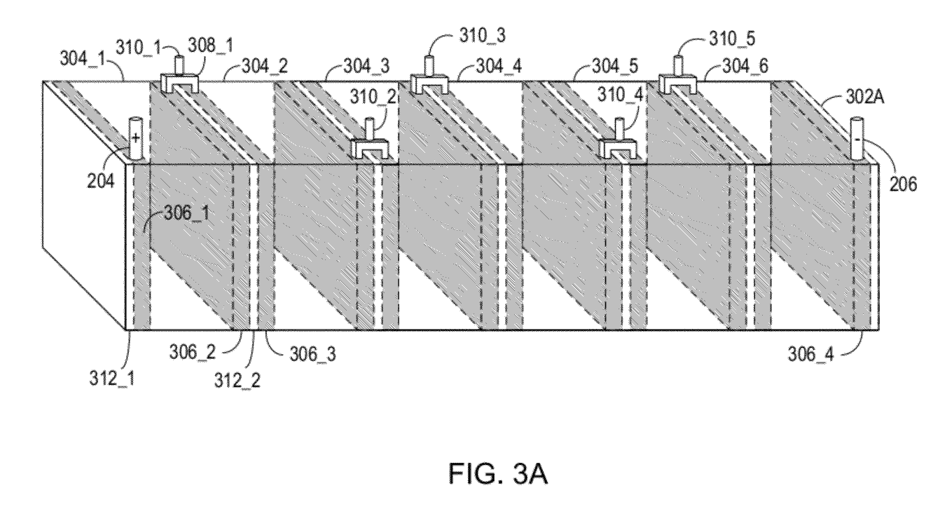

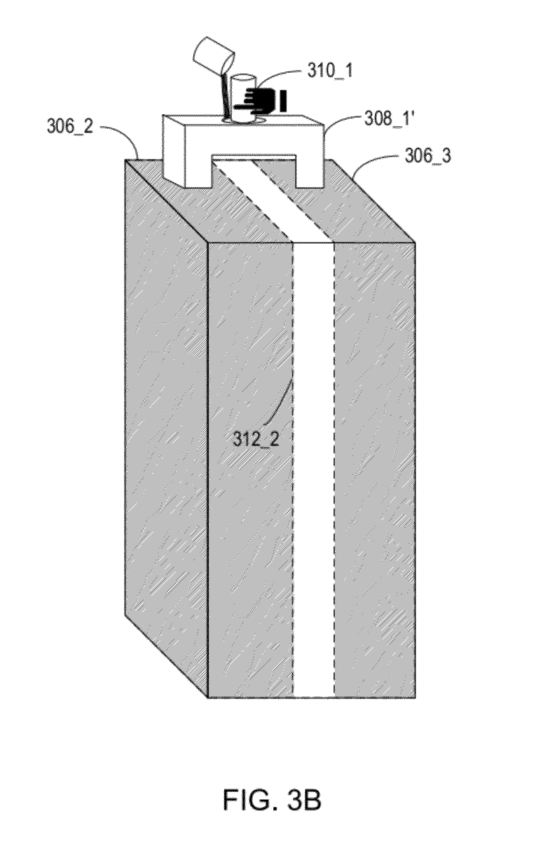

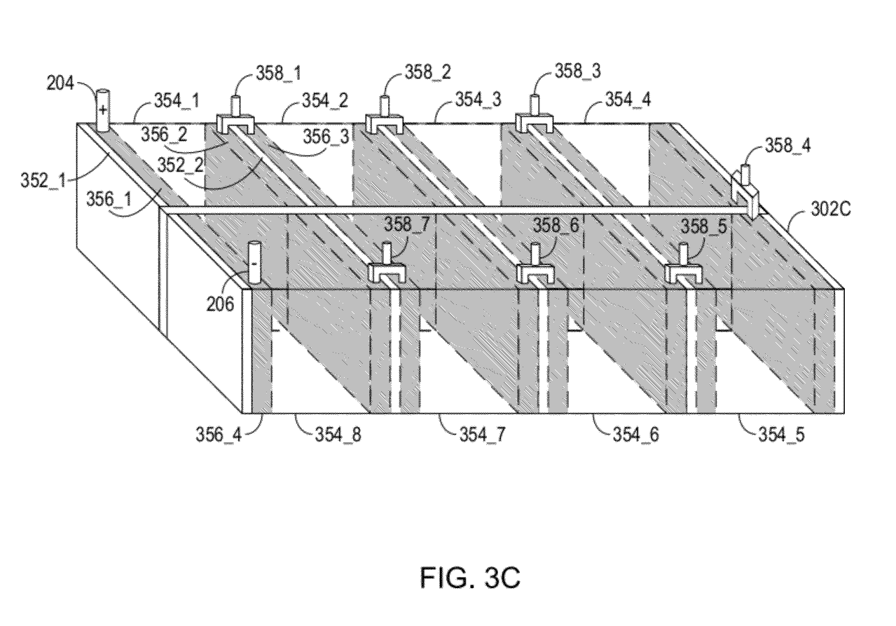

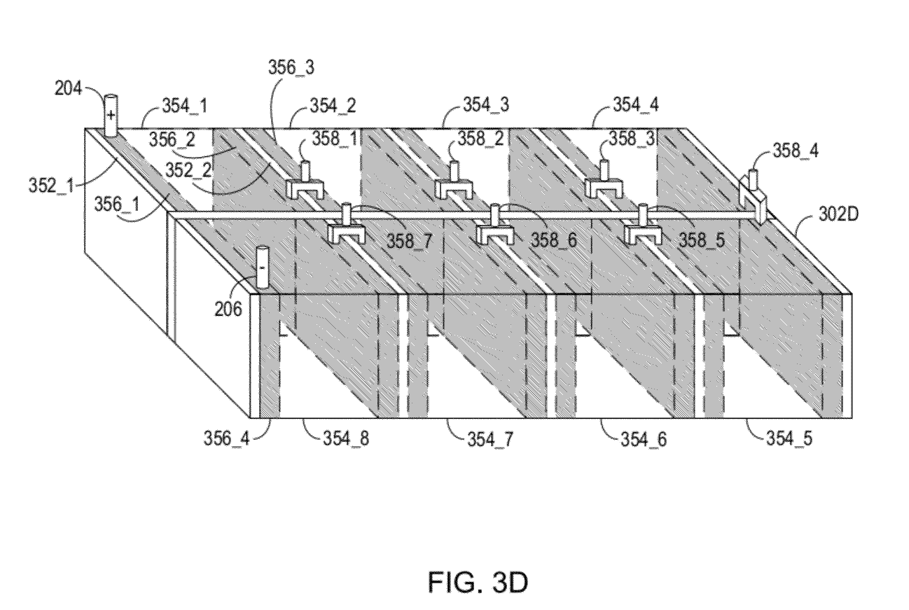

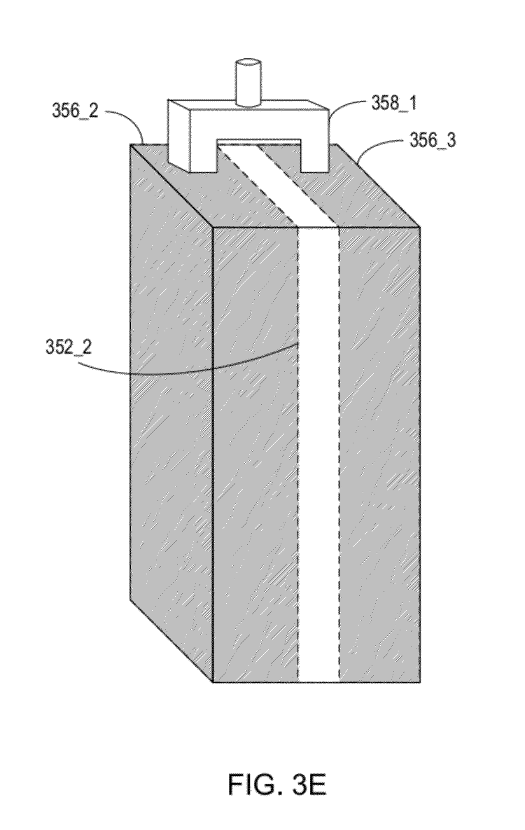

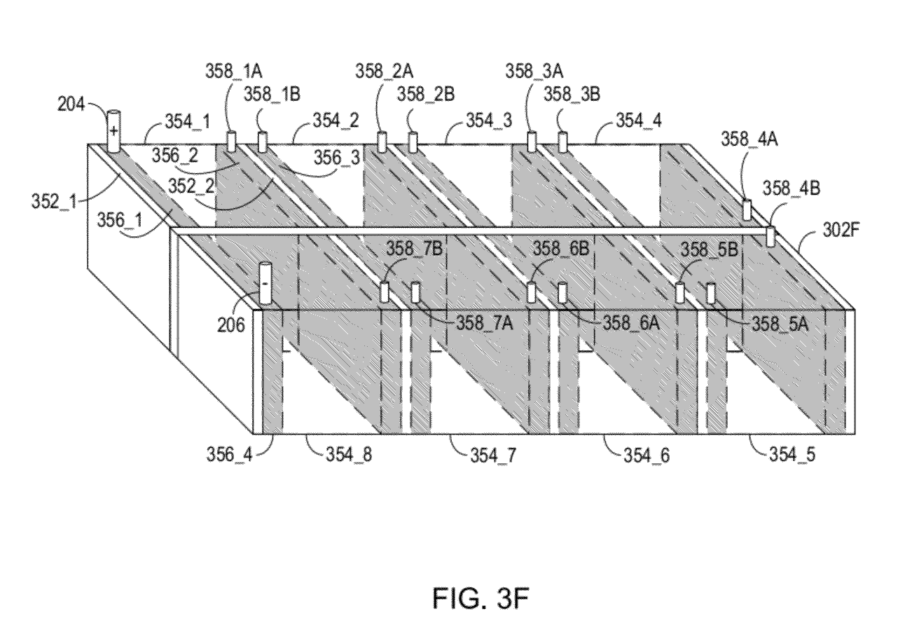

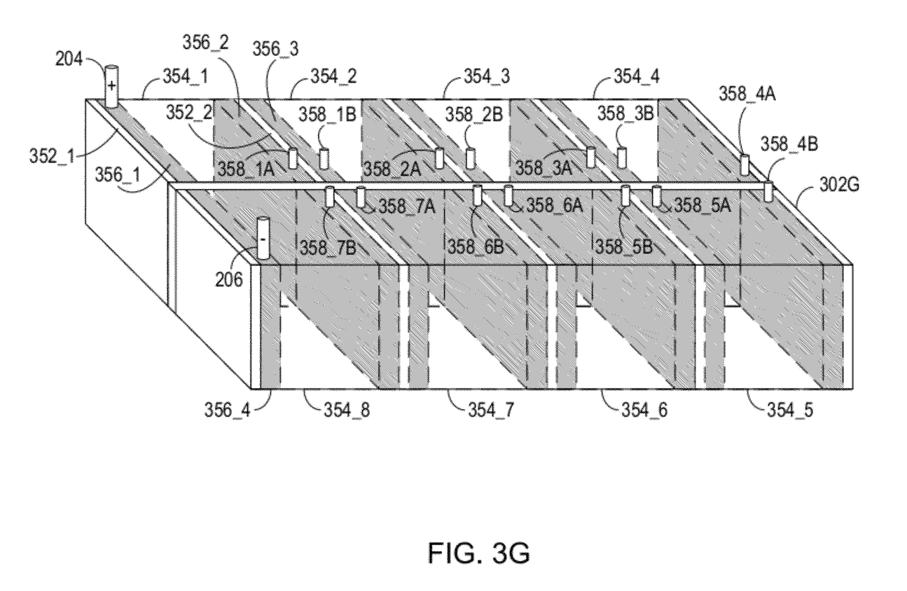

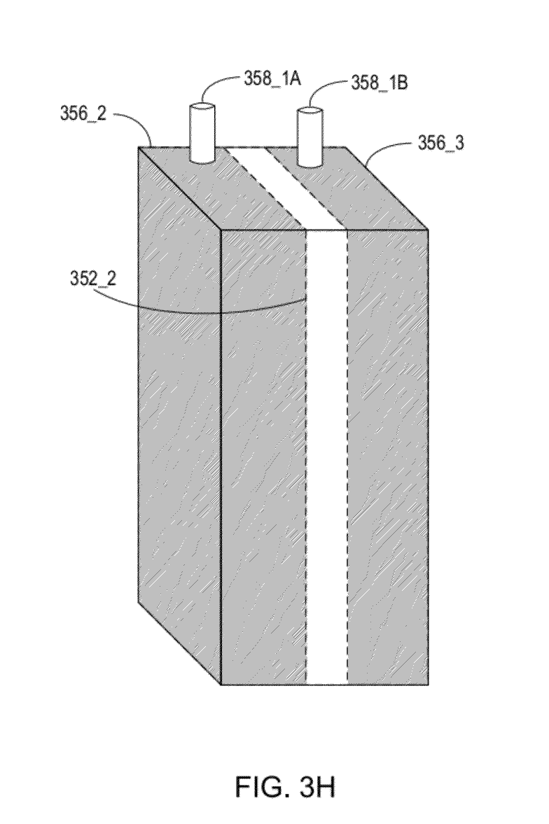

FIG. 3A illustrates an internal structure of a battery with embedded detecting units, e.g., the battery 202A in FIG. 2A or the battery 202B in FIG. 2B, in accordance with one embodiment of the present invention. FIG. 3A is described in combination with FIG. 2A and FIG. 2B.

In the example of FIG. 3A, a battery 302A, which represents the battery 202A in FIG. 2A or the battery 202B in FIG. 2B, includes multiple battery cells 304_1-304_6 separated by isolating plates. Any number of battery cells can be included in the battery 302A.

An isolating plate 312_1 is used to isolate the battery 302A at one side of the battery 302A. An isolating plate 312_2 is used to separate the battery cell 304_1 from the battery cell 304_2. Electric plates 306_1 and 306_2, which respectively function as a positive plate and a negative plate of the battery cell 304_1, can be configured in the battery cell 304_1 next to the isolating plates 312_1 and 312_2. Electrolyte liquid, e.g., acid liquid, can be filled in a space between the electric plates 306_1 and 306_2 of the battery cell 304_1. Similarly, positive and negative plates of the battery cells 304_2-304_6 can also be configured in the battery cells 304_2-304_6 next to the corresponding isolating plates.

An electric bar 308_1, e.g., a lead bar, is coupled between the negative plate 306_2 of the battery cell 304_1 and a positive plate 306_3 of the battery cell 304_2 to couple the battery cell 304_1 and the battery cell 304_2 in series. Similarly, corresponding electric bars can be coupled between adjacent electric plates of the battery cells 304_2 and 304_3, 304_3 and 304_4, 304_4 and 304_5, and 304_5 and 304_6 to connect the battery cells 304_2-304_6 in series.

Furthermore, multiple detecting units can be coupled to the battery cells 304_1-304_6 to detect the status of the battery cells 304_1-304_6. In one embodiment, an electric stick 310_1, e.g., a metal stick, is partially embedded into the electric bar 308_1 to detect the status of the battery cells 304_1 and 304_2, e.g., to output a negative voltage of the battery cell 304_1 and a positive voltage of the battery cell 304_2.

FIG. 3B illustrates how a detecting unit can be embedded in a battery, in accordance with one embodiment of the present invention. FIG. 3B is described in combination with FIG. 3A. As shown in the example of FIG. 3B, an electric shell 308_1′ of the electric bar 308_1 can be coupled between the electric plates 306_2 and 306_3. A hole exists on the top surface of the electric shell 308_1′. The diameter of the hole is greater than the diameter of the electric stick 310_1. The electric stick 310_1 is partially inserted into the electric shell 308_1′ via the hole and held in place for a period of time, during which liquid metal, e.g., liquid lead, can be infused into the electric shell 308_1′ via the space between the hole and the electric stick 310_1 until the liquid lead fills the electric shell 308_1′. As such, when the liquid lead becomes solid, the electric bar 308_1 is formed and the electric stick 310_1 is firmly attached to the electric bar 308_1.

Similarly, with reference back to FIG. 3A, electric sticks 310_2-310_5 can be partially embedded into corresponding electric bars and used to detect the status of the battery cells 304_2-304_6. Furthermore, electric sticks that function as the positive terminal 204 and the negative terminal 206 are fixed on the positive plate 306_1 of the battery cell 304_1 and a negative plate 306_4 of the battery cell 304_6 to detect and output positive and negative voltages of the battery 302A. Subsequently, a circuitry board can be connected to the battery cells 304_1-304_6 through the electric sticks 310_1-310_5 and the positive and negative terminals 204 and 206 (FIG. 3A). Circuitry to connect the pins of the connector 208 with the electric sticks 310_1-310_5 and the positive and negative terminals 204 and 206 can be formed on the circuitry board.

FIG. 3C illustrates an internal structure of a battery with embedded detecting units, in accordance with another embodiment of the present invention. FIG. 3C is described in combination with FIG. 2C and FIG. 2D.

In the example of FIG. 3C, a battery 302C, which represents the battery 202C in FIG. 2C or the battery 202D in FIG. 2D, includes multiple battery cells 354_1-354_8 separated by isolating plates. Any number of battery cells can be included in the battery 302C.

An isolating plate 352_1 is used to isolate the battery 302C at one side of the battery 302C. An isolating plate 352_2 is used to separate the battery cell 354_1 from the battery cell 354_2. Electric plates 356_1 and 356_2, which respectively function as a positive plate and a negative plate of the battery cell 354_1, can be configured in the battery cell 354_1 next to the isolating plates 352_1 and 352_2. Electrolyte liquid, e.g., acid liquid, can be filled in a space between the isolating plates 356_1 and 356_2 of the battery 354_1. Similarly, positive and negative plates of the battery cells 354_2-354_8 can also be configured in the battery cells 354_2-354_8 next to the corresponding isolating plates.

An electric bar 358_1, e.g., a lead bar, is coupled between the negative plate 356_2 of the battery cell 354_1 and a positive plate 356_3 of the battery cell 354_2 to couple the battery cell 354_1 and the battery cell 354_2 in series. Similarly, corresponding electric bars 358_2-358_7 can be coupled between adjacent electric plates of the battery cells 354_2 and 354_3, 354_3 and 354_4, 354_4 and 354_5, 354_5 and 354_6, 354_6 and 354_7, and 354_7 and 354_8 to connect the battery cells 354_2-354_8 in series.

The electric bars 358_1-358_7 function as detecting units to detect the status of the battery cells 354_1-354_8. In one embodiment, the electric bar 358_1 detects the status of the battery cells 354_1 and 354_2, e.g., to output a negative voltage of the battery cell 354_1 and a positive voltage of the battery cell 354_2.

In an alternative embodiment, the electric bars 358_1-358_7 are located in the middle areas of a battery 302D, shown as in FIG. 3D. Elements that are labeled similarly as those in FIG. 3C have similar functions and will not be described in details for brevity and clarity.

FIG. 3E illustrates how a detecting unit can be embedded in a battery, in accordance with one embodiment of the present invention. FIG. 3E is described in combination with FIG. 3C and FIG. 3D. In the example of FIG. 3E, an external mold (not shown) is placed on the surface of the electric plates 356_2 and 356_3. Liquid metal, e.g., liquid lead, can be infused into the external mold via a hole on the surface of the mold until the liquid lead fills the external mold. As such, when the liquid lead becomes solid, the electric bar 358_1 is formed with a predetermined height. The predetermined height is determined by the thickness of a circuitry board that covers the battery 302C via the electric bars 358_2-358_7, the positive terminal 204, and the negative terminal 206.

Similarly, with reference back to FIG. 3C or FIG. 3D, the electric bars 358_2-358_7 can be formed with the predetermined height and used to detect the status of the battery cells 354_2-354_8. Furthermore, electric bars that function as the positive terminal 204 and the negative terminal 206 are fixed on the positive plate 356_1 of the battery cell 354_1 and a negative plate 356_4 of the battery cell 354_8 to detect and output positive and negative voltages of the battery 302C or 302D. Subsequently, a circuitry board can be connected to the battery cells 354_1-354_8 through the electric bars 358_1-358_7 and the positive and negative terminals 204 and 206 (FIG. 3C or FIG. 3D). Circuitry to connect the pins of the connector 208 with the electric bars 358_1-358_7 and the positive and negative terminals 204 and 206 can be formed on the circuitry board. Advantageously, the detecting units, e.g., the electric bars 358_1-358_7, are formed with simpler manufacture procedures. As a result, the detecting units are firmly formed on the battery cells 354_1-354_8.

FIG. 3F illustrates an internal structure of a battery with embedded detecting units, in accordance with another embodiment of the present invention. FIG. 3F is described in combination with FIG. 2C and FIG. 2D. In the example of FIG. 3F, the battery 302F represents the battery 202C in FIG. 2C or the battery 202D in FIG. 2D.

In the example of FIG. 3F, an electric bar 358_1A, e.g., a lead bar, is coupled to the negative plate 356_2 of the battery cell 354_1 and an electric bar 358_1B is coupled to the positive plate 356_3 of the battery cell 354_2. Similarly, corresponding electric bars 358_2A-358_7A and 358_2B-358_7B can be coupled to adjacent electric plates of the battery cells 354_2-354_8.

The electric bars 358_1A-358_7A and 358_1B-358_7B function as detecting units to detect the status of the battery cells 354_1-354_8. In one embodiment, the electric bar 358_1A detects the status of the negative plate of the battery cell 354_1, e.g., to output a negative voltage of the battery cell 354_1. The electric bar 358_1B detects the status of the positive plate of the battery cell 354_2, e.g., to output a positive voltage of the battery cell 354_2.

In an alternative embodiment, the electric bars 358_1A-358_7A and 358_1B-358_7B are located in the middle areas of a battery 302G, shown as in FIG. 3G. Elements that are labeled similarly as those in FIG. 3F have similar functions and will not be described in details for brevity and clarity.

FIG. 3H illustrates how detecting units can be embedded in a battery, in accordance with another embodiment of the present invention. FIG. 3H is described in combination with FIG. 3F and FIG. 3G. The electric bars 358_1A-358_1B are manufactured in a similar way as the electric bar 358_1 in FIG. 3E and therefore have similar functions.

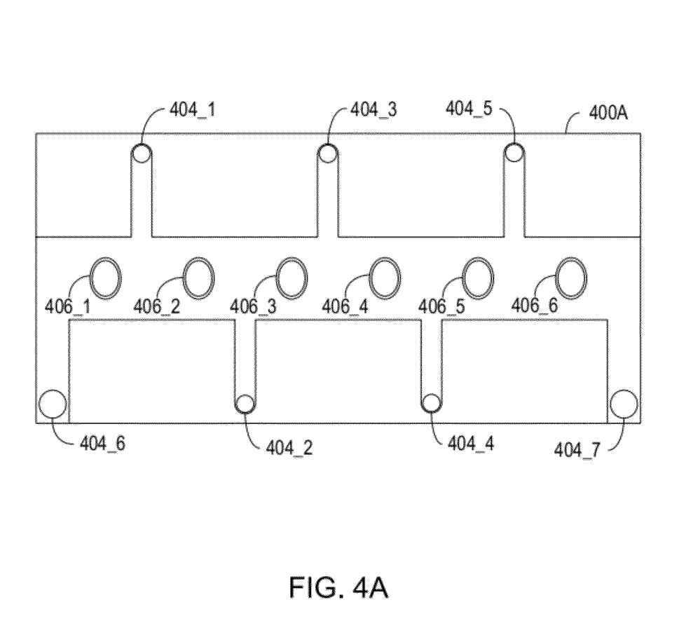

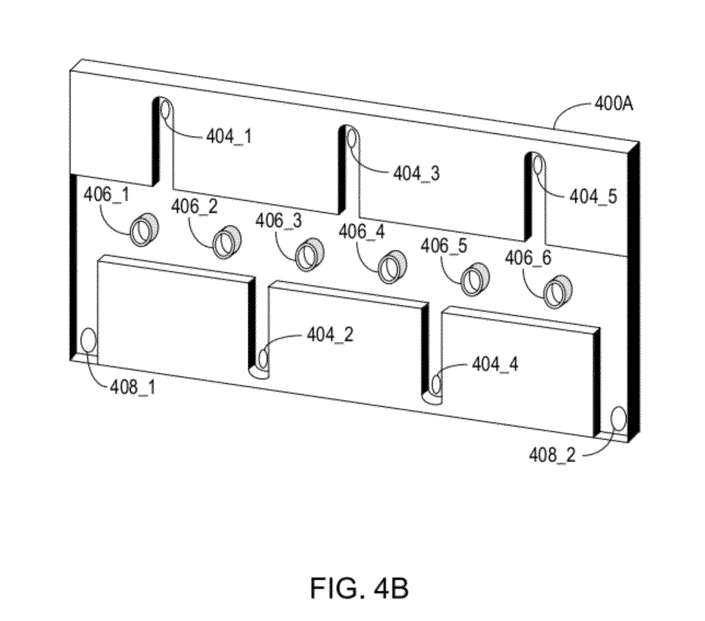

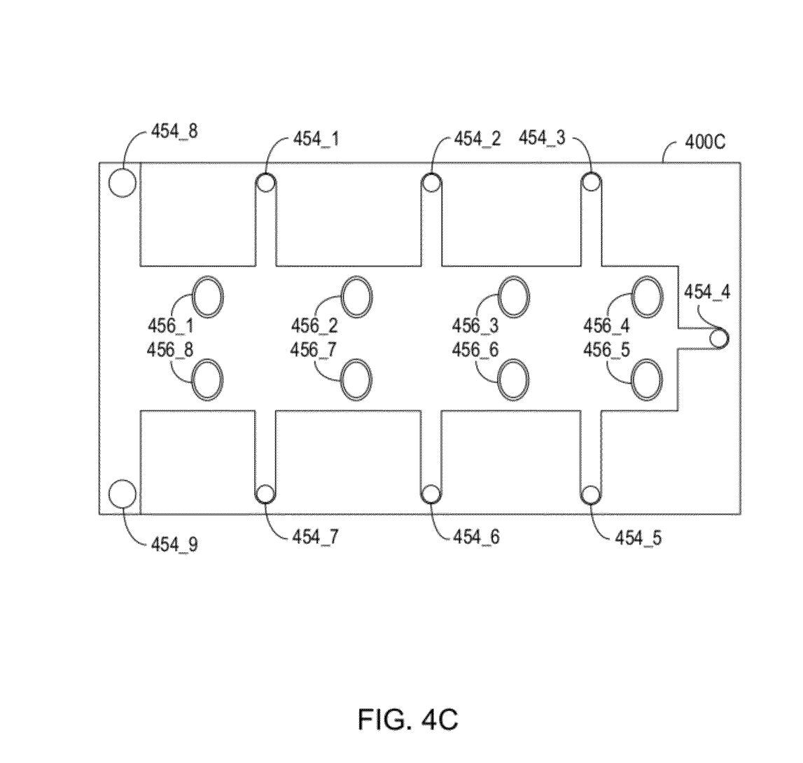

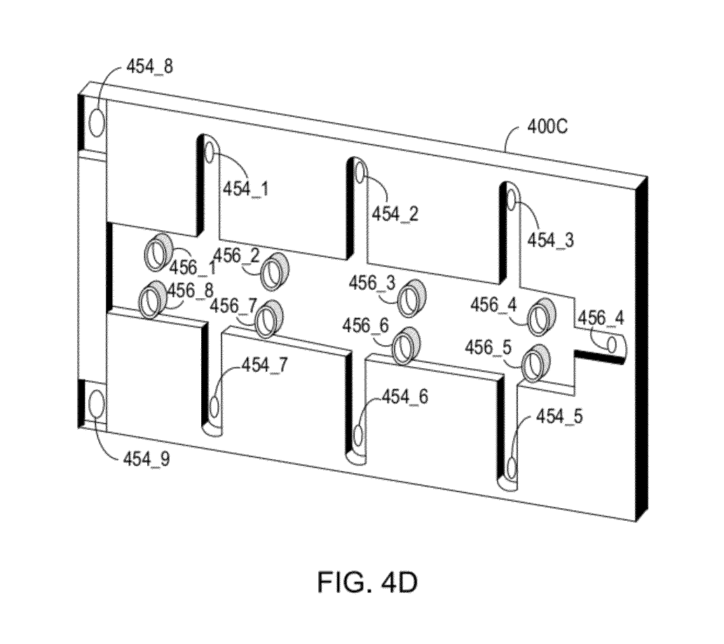

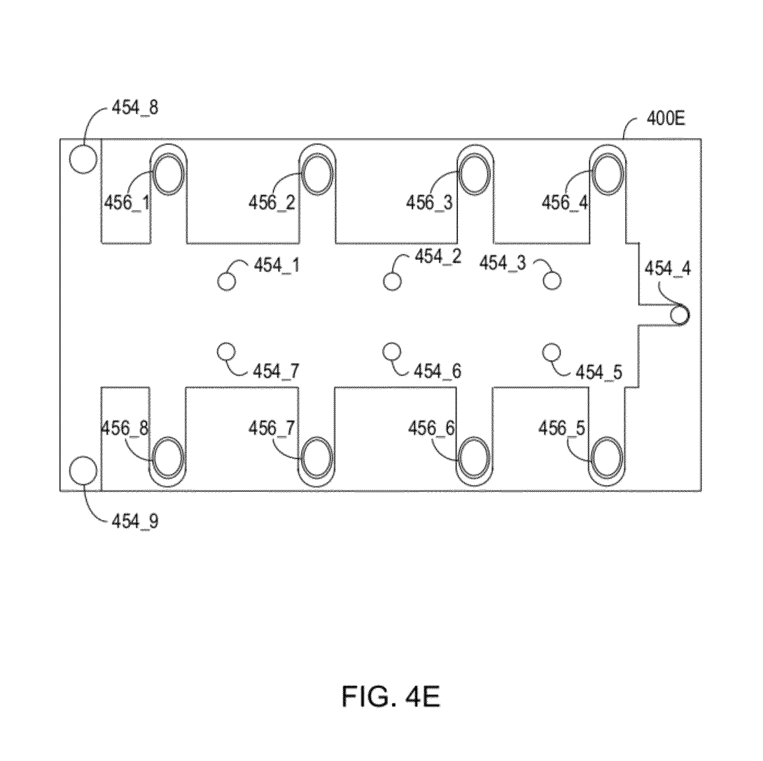

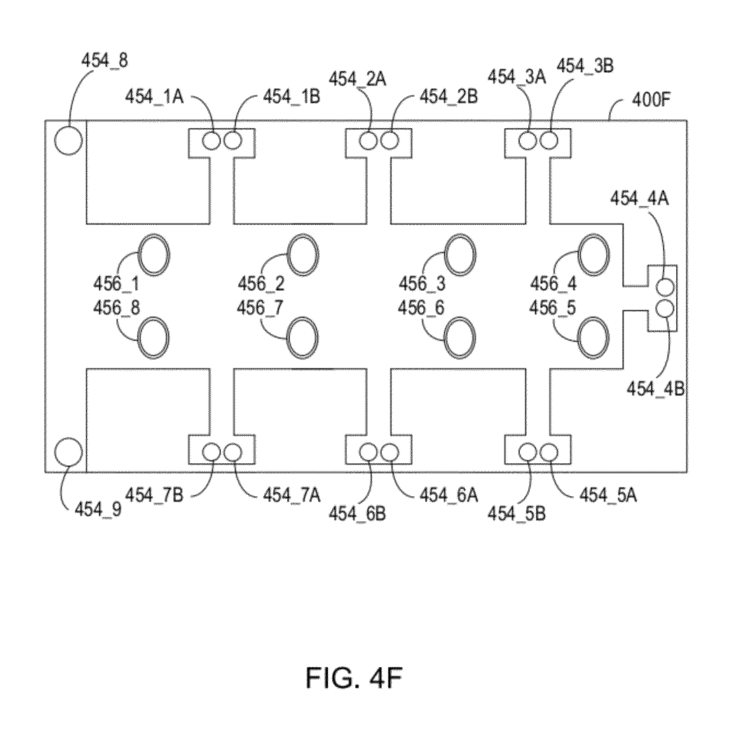

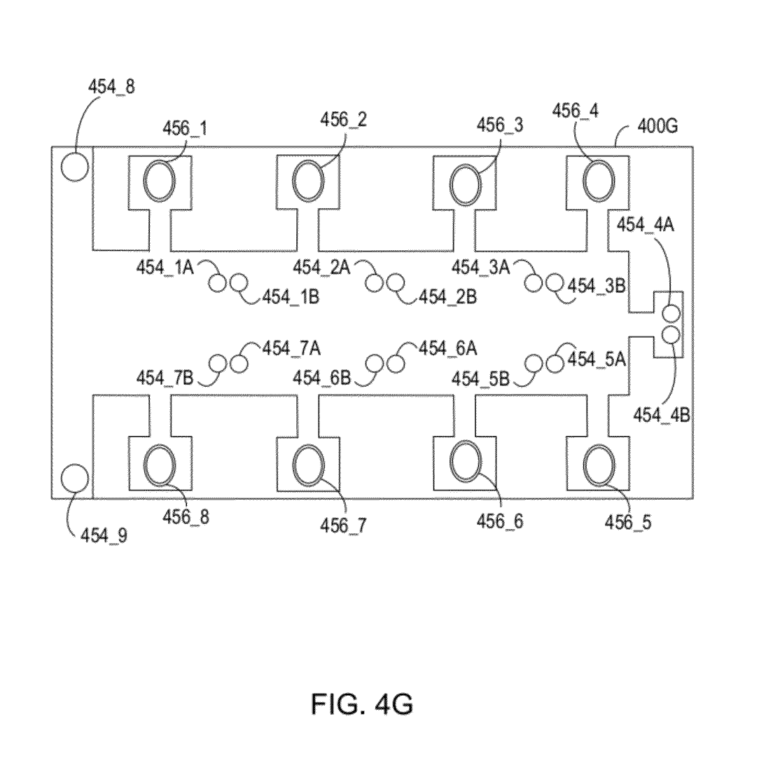

FIG. 4A and FIG. 4B illustrate a circuitry board 400A that can be used to connect multiple interfaces, e.g., the pins of the connector 208 in FIG. 2A and/or FIG. 2B, with multiple detecting units embedded in the battery, in accordance with one embodiment of the present invention. FIG. 4A and FIG. 4B are described in combination with FIG. 2A and FIG. 3A.

FIG. 4A illustrates an ichnography of the circuitry board 400A. FIG. 4B illustrates a tridimensional graph of the circuitry board 400A. The size and shape of the circuitry board 400A can match the size and shape of the battery 302A. As such, the circuitry board 400A fits well over the inner battery cells of the battery 302A.

As shown in the ichnography of FIG. 4A, the positions of holes 404_1-404_7 on the circuitry board 400A can match the positions of the electric sticks 310_1-310_5 and the positive and negative terminals 204 and 206 in the battery 302A, and the sizes of the holes 404_1-404_7 can match the sizes of the electric sticks 310_1-310_5 and the positive and negative terminals 204 and 206. As such, when the circuitry board 400A is placed on the battery cells 304_1-304_6 of the battery 302A, the electric sticks 310_1-310_5 and the positive and negative terminals 204 and 206 can pass through the circuitry board 400A via the corresponding holes 404_1-404_7.

Furthermore, the positions of holes 406_1-406_6 on the circuitry board 400A can match positions of the spaces between the positive and negative plates of the battery cells 304_1-304_6. As such, when the circuitry board 400A is placed on the battery 302A, the holes 406_1-406_6 are directly over the spaces between the positive and negative plates of the battery cells 304_1-304_6. Electrolyte liquid can be infused into the spaces between the positive and negative plates of the battery cells 304_1-304_6 via the holes 406_1-406_6 after the circuitry board 400A is placed on the battery 302A.

As shown in the tridimensional graph of FIG. 4B, a middle area of the circuitry board 400A, where the holes 406_1-406_6 are located, is recessed relative to other areas of the circuitry board 400A. Additionally, channels from the holes 404_1-404_7 to the middle area are also recessed relative to other areas of the circuitry board 400A. As such, the circuitry for connecting the pins of the connector 208 with the electric sticks 310_1-310_5 and the positive and negative terminals 204 and 206 can be placed in the channels and the middle area. Advantageously, wires of the circuitry will not protrude from the surface of the circuitry board 400A so that the surface of the circuitry board 400A is relatively flat. As such, the battery 302A can be readily airproofed in a subsequent operation.

FIG. 4C and FIG. 4D illustrate a circuitry board 400C that can be used to connect multiple interfaces, e.g., the pins of the connector 208 in FIG. 2C and/or FIG. 2D, with multiple detecting units embedded in the battery, in accordance with one embodiment of the present invention. FIG. 4C and FIG. 4D are described in combination with FIG. 2C and FIG. 3C.

FIG. 4C illustrates an ichnography of the circuitry board 400C. FIG. 4D illustrates a tridimensional graph of the circuitry board 400C. The size and shape of the circuitry board 400C can match the size and shape of the battery 302C. As such, the circuitry board 400C fits well over the inner battery cells of the battery 302C.

As shown in the ichnography of FIG. 4C, the positions of holes 454_1-454_9 on the circuitry board 400C can match the positions of the electric bars 358_1-358_7 and the positive and negative terminals 204 and 206 in the battery 302C, and the sizes of the holes 454_1-454_9 can match the sizes of the electric sticks 358_1-358_7 and the positive and negative terminals 204 and 206. As such, when the circuitry board 400C is placed on the battery cells 354_1-354_8 of the battery 302C, the electric bars 358_1-358_7 and the positive and negative terminals 204 and 206 can pass through the circuitry board 400C via the corresponding holes 454_1-454_9.

Furthermore, the positions of holes 456_1-456_8 on the circuitry board 400C can match positions of the spaces between the positive and negative plates of the battery cells 354_1-354_8. As such, when the circuitry board 400C is placed on the battery 302C, the holes 456_1-456_8 are directly over the spaces between the positive and negative plates of the battery cells 354_1-354_8. Electrolyte liquid can be infused into the spaces between the positive and negative plates of the battery cells 354_1-354_8 via the holes 456_1-456_8 after the circuitry board 400C is placed on the battery 302C.

As shown in the tridimensional graph of FIG. 4D, a middle area of the circuitry board 400C, where the holes 456_1-456_8 are located, is recessed relative to other areas of the circuitry board 400C. Additionally, channels from the holes 454_1-454_9 to the middle area are also recessed relative to other areas of the circuitry board 400C. As such, the circuitry for connecting the pins of the connector 208 with the electric bars 358_1-358_7 and the positive and negative terminals 204 and 206 can be placed in the channels and the middle area. Advantageously, wires of the circuitry will not protrude from the surface of the circuitry board 400C so that the surface of the circuitry board 400C is relatively flat. Therefore, the battery 302C can be readily airproofed in a subsequent operation.

In an alternative embodiment, the holes 456_1-456_8 are located in the side areas of a circuitry board 400E and the holes 454_1-454_3 and 454_5-454_7 are located in the middle area of the circuitry board 400E, as shown in FIG. 4E. In the example of FIG. 4E, the positions of holes 454_1-454_9 on the circuitry board 400E can match the positions of the electric bars 358_1-358_7 and the positive and negative terminals 204 and 206 in the battery 302D in FIG. 3D. Elements that are labeled similarly as those in FIG. 4C and FIG. 4D function in a similar way as described above.

FIG. 4F illustrates a circuitry board 400F that can be used to connect multiple interfaces, e.g., the pins of the connector 208 in FIG. 2C and/or FIG. 2D, with multiple detecting units embedded in the battery, in accordance with one embodiment of the present invention. FIG. 4F is described in combination with FIG. 2C and FIG. 3F.

The size and shape of the circuitry board 400F can match the size and shape of the battery 302F. As such, the circuitry board 400F fits well over the inner battery cells of the battery 302F.

As shown in the ichnography of FIG. 4F, the positions of holes 454_1A-454_7A, 454_1B-454_1B, 454_8 and 454_9 on the circuitry board 400F can match the positions of the electric bars 358_1A-358_7A and the 358_1B-358_1B and the positive and negative terminals 204 and 206 in the battery 302F, and the sizes of the holes 454_1A-454_7A, 454_1B-454_1B, 454_8 and 454_9 can match the sizes of the electric sticks 358_1A-358_7A and 358_1B-358_1B and the positive and negative terminals 204 and 206. As such, when the circuitry board 400F is placed on the battery cells 354_1-354_8 of the battery 302F, the electric bars 358_1A-358_7A and 358_1B-358_1B and the positive and negative terminals 204 and 206 can pass through the circuitry board 400F via the corresponding holes 454_1A-454_7A, 454_1B-454_1B, 454_8 and 454_9.

Furthermore, the positions of holes 456_1-456_8 on the circuitry board 400F can match positions of the spaces between the positive and negative plates of the battery cells 354_1-354_8. As such, when the circuitry board 400F is placed on the battery 302F, the holes 456_1-456_8 are directly over the spaces between the positive and negative plates of the battery cells 354_1-354_8. Electrolyte liquid can be infused into the spaces between the positive and negative plates of the battery cells 354_1-354_8 via the holes 456_1-456_8 after the circuitry board 400F is placed on the battery 302F.

In an alternative embodiment, the holes 454_1A-454_3A, 454_5A-454_7A, 454_1B-454_3B and 454_5B-454_7B are located in the middle area of a circuitry board 400G and the holes 456_1-456_8 are located in the side area of the circuitry board 400G as shown in FIG. 4G. In the example of FIG. 4G, the positions of holes 454_1A-454_7A, 454_1B-454_1B, 454_8 and 454_9 on the circuitry board 400G can match the positions of the electric bars 358_1A-358_7A and the 358_1B-358_1B and the positive and negative terminals 204 and 206 in the battery 302G. Elements that are labeled similarly as those in FIG. 4F function in a similar way as described above.

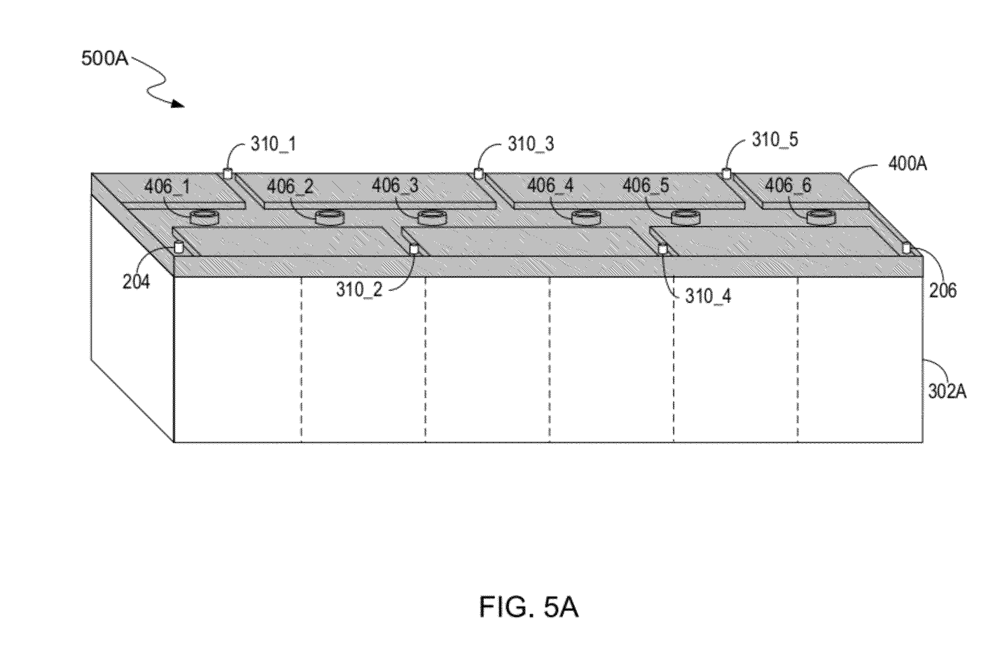

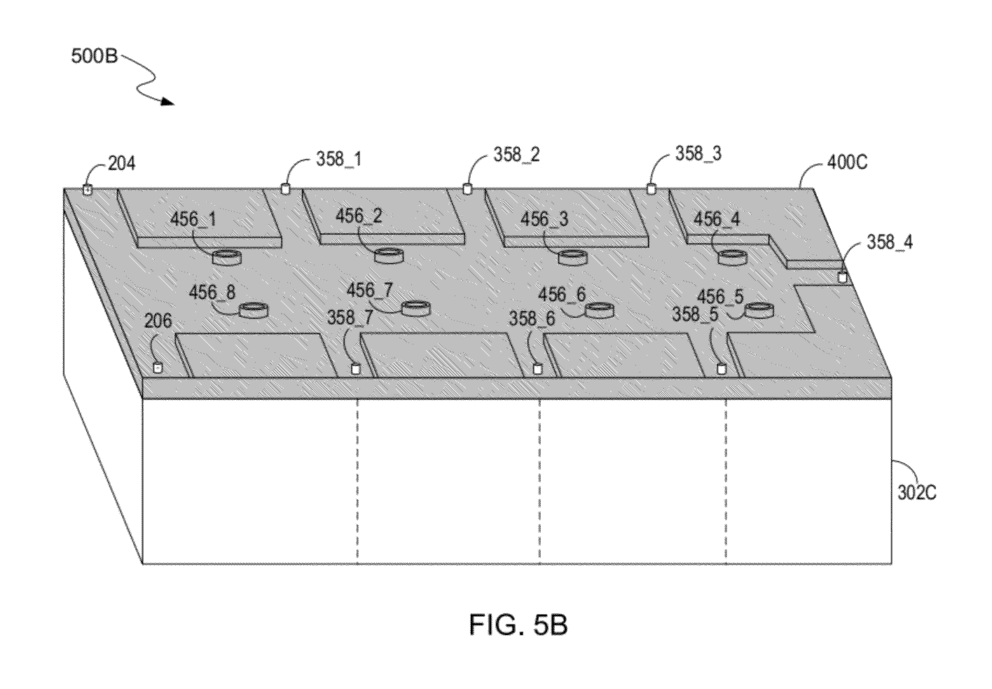

FIG. 5A shows a diagram of a battery 500A, e.g., the battery 302A in FIG. 3A, after a circuitry board, e.g., the circuitry board 400A in FIG. 4A and/or FIG. 4B, is placed on the battery 302A, in accordance with one embodiment of the present invention. FIG. 5A is described in combination with FIG. 2A, FIG. 2B, FIG. 3A, FIG. 4A and FIG. 4B.

As shown in FIG. 5A, the electric sticks 310_1-310_5 and the positive and negative terminals 204 and 206 protrude through the circuitry board 400A, and other details related to the inner battery cells 304_1-304_6 can be hidden by the circuitry board 400A after the circuitry board 400A is placed on the battery 302A. The tops of the electric sticks 310_1-310_5 and the positive and negative terminals 204 and 206 are at the same horizontal level as the top of the circuitry board 400A. Additionally, the holes 406_1-406_6 are directly over the spaces between the positive and negative plates of the battery cells 304_1-304_6. In FIG. 5A, positions of the battery cells 304_1-304_6 are roughly marked by broken lines on the battery 302A.

FIG. 5B shows a diagram of a battery 500B, e.g., the battery 302C in FIG. 3C, after a circuitry board, e.g., the circuitry board 400C in FIG. 4C and/or FIG. 4D, is placed on the battery 302C, in accordance with one embodiment of the present invention. FIG. 5B is described in combination with FIG. 2C, FIG. 2D, FIG. 3C, FIG. 4C and FIG. 4D.

As shown in FIG. 5B, the electric bars 358_1-358_7 and the positive and negative terminals 204 and 206 protrude through the circuitry board 400C, and other details related to the inner battery cells 354_1-354_8 can be hidden by the circuitry board 400C after the circuitry board 400C is placed on the battery 302C. The tops of the electric bars 358_1-358_7 and the positive and negative terminals 204 and 206 are in the same horizontal level as the top of the circuitry board 400C. More specifically, as mentioned in relation to FIG. 3E, the electric bars 358_2-358_7 can be formed with a predetermined height, e.g., determined by the thickness of the circuitry board 400A. In a similar manner, the positive and negative terminals 204 and 206 can be formed with the predetermined height. Additionally, the holes 456_1-456_8 are directly over the spaces between the positive and negative plates of the battery cells 354_1-354_8. In FIG. 5B, positions of the battery cells 354_1-354_8 are roughly marked by broken lines on the battery 302C.

In alternative embodiments, the battery 500B can be modified to match the circuitry boards 400E, 400F and 400G that are placed on the battery 302D, 302F and 302G respectively.

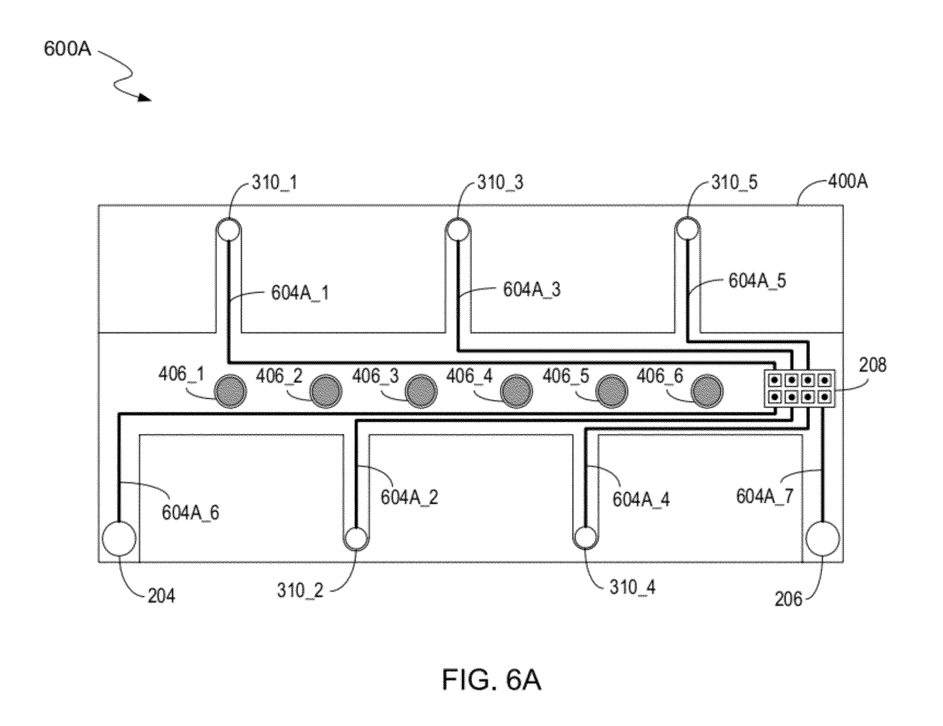

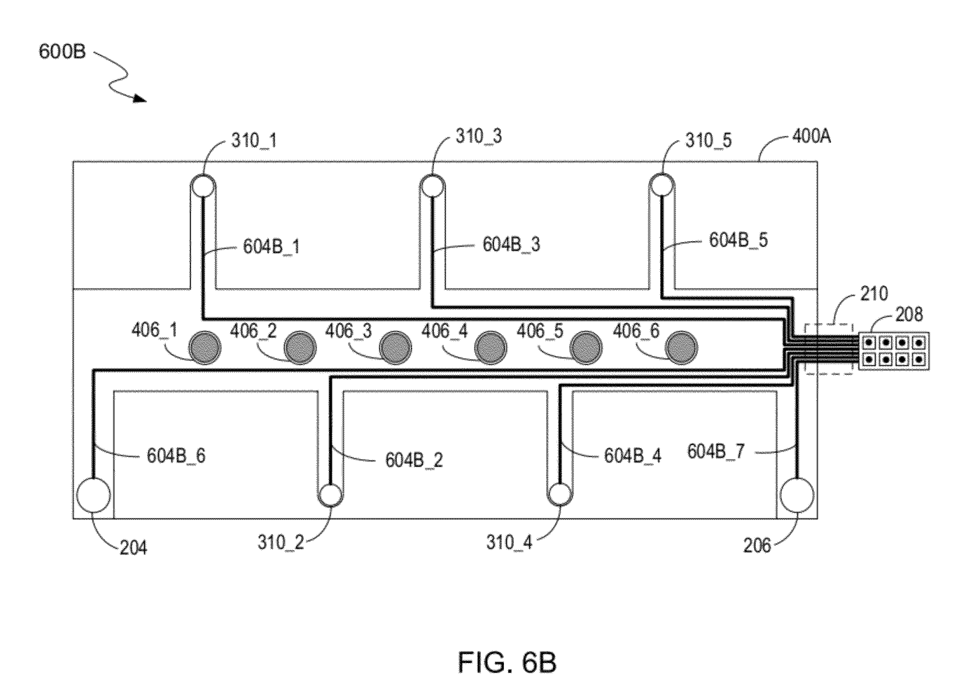

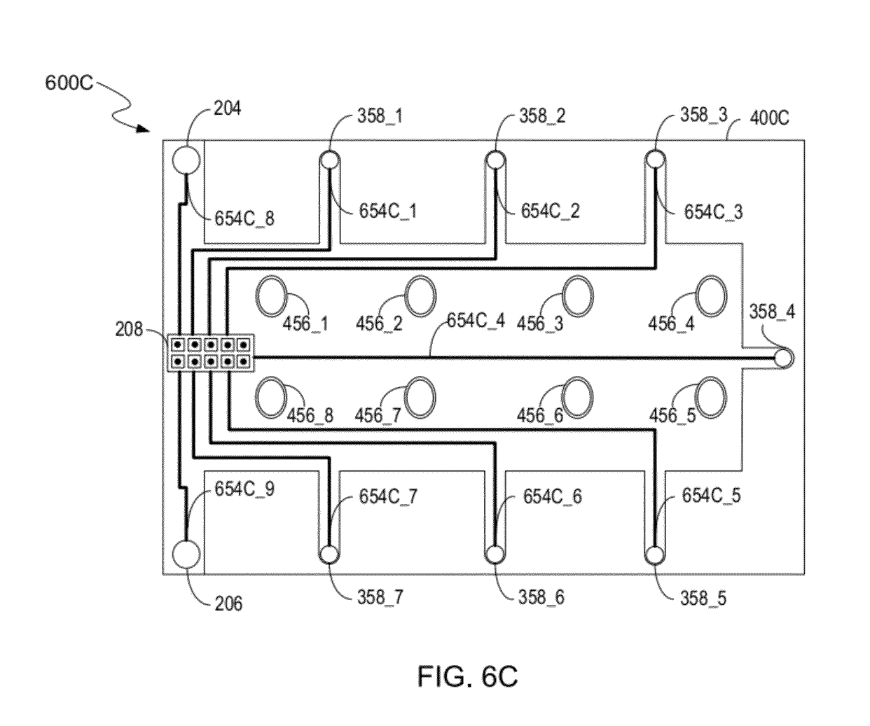

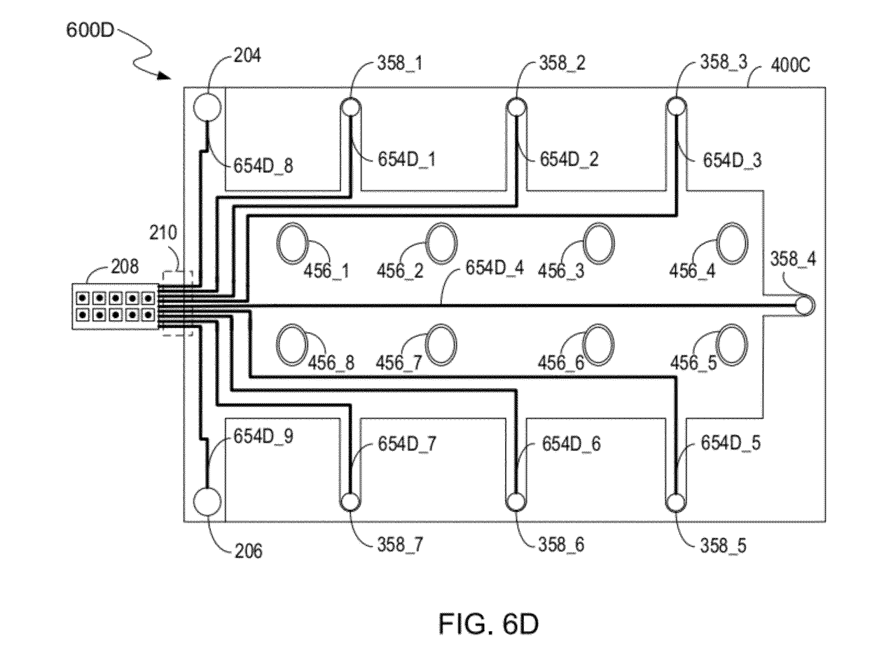

FIG. 6A illustrates a diagram of circuitry 600A on a circuitry board, e.g., the circuitry board 400A in FIG. 4A and/or FIG. 4B, in accordance with one embodiment of the present invention. FIG. 6A is described in combination with FIG. 2A, FIG. 3A, FIG. 4A and FIG. 4B.

As shown in the example of FIG. 6A, the connector 208 is mounted on the circuitry board 400A, in one embodiment. When the circuitry board 400A is placed on the battery 302A, the electric sticks 310_1-310_5 and the positive and negative terminals 204 and 206 can protrude through the circuitry board 400A via the corresponding holes. As described above, the electric sticks 310_1-310_5 function as the detecting units to detect the status of the inner battery cells 304_1-304_6, and the positive and negative terminals 204 and 206 represent the positive and negative terminals of the battery 302A. Wires 604A_1-604A_7 connecting the detecting units, e.g., the electric sticks 310_1-310_5, and the positive and negative terminals 204 and 206 to the connector 208 are located in the recessed channels and middle area of the circuitry board 400A. Subsequently, the wires 604A_1-604A_7 are arranged side-by-side in the middle area and finally are connected to the connector 208 via corresponding pins.

During operation, a battery management unit can monitor the status of the inner battery cells 304_1-304_6 as well as the battery 302A, e.g., the voltages across the inner battery cells 304_1-304_6 and the battery 302A, via the corresponding pins of the connector 208 which are coupled to the detecting units, e.g., the electric sticks 310_1-310_5, and to the positive and negative terminals 204 and 206.

Additionally, after the circuitry board 400A is mounted on the battery 302A, electrolyte liquid can be infused into the spaces between the positive and negative plates of the battery cells 304_1-304_6 via the holes 406_1-406_6 until the electrolyte liquid fills in the battery cells 304_1-304_6. Then, the holes 406_1-406_6 can be sealed to prevent leaking.

After the wires 604A_1-604A_7 are located on the circuitry board 400A, and after the holes 406_1-406_6 are sealed, the battery 302A can be airproofed by a cover board. All the elements can be hidden by the cover board except the positive and negative terminals 204 and 206 as well as the connector 208, such as shown in FIG. 2A.

FIG. 6B illustrates a diagram of circuitry 600B located on a circuitry board, e.g., the circuitry board 400A in FIG. 4A and/or FIG. 4B, in accordance with another embodiment of the present invention. Elements that are labeled similarly as those in FIG. 6A have similar functions and so will not be described in details. FIG. 6B is described in combination with FIG. 2B, FIG. 3A, FIG. 4A and FIG. 4B.

As shown in the example of FIG. 6B, when the circuitry board 400A is placed on the battery 302A, the electric sticks 310_1-310_5 and the positive and negative terminals 204 and 206 can extend through the circuitry board 400A via corresponding holes. As described above, the electric sticks 310_1-310_5 function as detecting units to detect the status of the inner battery cells 304_1-304_6, and the positive and negative terminals 204 and 206 represent the positive and negative terminals of the battery 302A. Wires 604B_1-604B_7 connecting the detecting units, e.g., the electric sticks 310_1-310_5, and the positive and negative terminals 204 and 206 to the connector 208 are located in the recessed channels and middle area of the circuitry board 400A. Subsequently, the wires 604B_1-604B_7 are arranged side by side in the middle area and encased together in a flexible medium to create the appearance of a ribbon, which can be seen as the cable 210.

After the battery 302A is airproofed, the cable 210, which includes the wires 604B_1-604B_7, extends from the battery 202B and can be connected to the connector 208. Corresponding pins of the connector 208 can be connected to the detecting units, e.g., the electric sticks 310_1-310_5, and the positive and negative terminals 204 and 206 via the corresponding wires 604B_1-604B_7 in the cable 210, as shown in FIG. 2B.

FIG. 6C illustrates a diagram of circuitry 600C on a circuitry board, e.g., the circuitry board 400C in FIG. 4C and/or FIG. 4D, in accordance with one embodiment of the present invention. FIG. 6C is described in combination with FIG. 2C, FIG. 3C, FIG. 4C and FIG. 4D.

As shown in the example of FIG. 6C, the connector 208 is mounted on the circuitry board 400C, in one embodiment. When the circuitry board 400C is placed on the battery 302C, the electric bars 358_1-358_7 and the positive and negative terminals 204 and 206 can protrude through the circuitry board 400C via the corresponding holes. As described above, the electric bars 358_1-358_7 function as the detecting units to detect the status of the inner battery cells 354_1-354_7, and the positive and negative terminals 204 and 206 represent the positive and negative terminals of the battery 302C. Wires 654C_1-654C_9 connecting the detecting units, e.g., the electric bars 358_1-358_7, and the positive and negative terminals 204 and 206 to the connector 208 are located in the recessed channels and middle area of the circuitry board 400C. Subsequently, the wires 654C_1-654C_9 are arranged side-by-side in the middle area and finally are connected to the connector 208 via corresponding pins.

During operation, a battery management unit can monitor the status of the inner battery cells 354_1-354_8 as well as the battery 302C, e.g., the voltages across the inner battery cells 354_1-354_8 and the battery 302C, via the corresponding pins of the connector 208 which are coupled to the detecting units, e.g., the electric bars 358_1-358_7, and to the positive and negative terminals 204 and 206.

Additionally, after the circuitry board 400C is mounted on the battery 302C, electrolyte liquid can be infused into the spaces between the positive and negative plates of the battery cells 354_1-354_8 via the holes 456_1-456_8 until the electrolyte liquid fills in the battery cells 354_1-354_8. Then, the holes 456_1-456_8 can be sealed to prevent leaking.

In one embodiment, the ends of the wires 654C_1-654C_9 are welded by lead-tin alloy to connect the electric bars 358_1-358_7 and the positive and negative terminals 204 and 206 to the pins of the connector 208. In another embodiment, multiple metal sheets, e.g., copper sheets, are welded to the electric bars 358_1-358_7, the positive and negative terminals 204 and 206 and the pins of the connector 208. Subsequently, the ends of the wires 654C_1-654C_9 are welded by lead-tin alloy on the metal sheets to connect the electric bars 358_1-358_7 and the positive and negative terminals 204 and 206 to the pins of the connector 208.

After the wires 654C_1-654C_9 are welded on the circuitry board 400C, and after the holes 456_1-456_6 are sealed, the battery 302C can be airproofed by a cover board. All the elements can be hidden by the cover board except the positive and negative terminals 204 and 206 as well as the connector 208, such as shown in FIG. 2C.

FIG. 6D illustrates a diagram of circuitry 600D located on a circuitry board, e.g., the circuitry board 400C in FIG. 4C and/or FIG. 4D, in accordance with another embodiment of the present invention. Elements that are labeled similarly as those in FIG. 6D have similar function and will not be described in details for brevity and clarity. FIG. 6D is described in combination with FIG. 2D, FIG. 3D, FIG. 4D and FIG. 4D.

As shown in the example of FIG. 6D, when the circuitry board 400C is placed on the battery 302C, the electric bars 358_1-358_7 and the positive and negative terminals 204 and 206 can extend through the circuitry board 400C via corresponding holes. As described above, the electric bars 358_1-358_7 function as detecting units to detect the status of the inner battery cells 354_1-354_8, and the positive and negative terminals 204 and 206 represent the positive and negative terminals of the battery 302C. Wires 654D_1-654D_9 connecting the detecting units, e.g., the electric bars 358_1-358_7, and the positive and negative terminals 204 and 206 to the connector 208 are located in the recessed channels and middle area of the circuitry board 400C. Subsequently, the wires 654D_1-654D_9 are arranged side by side in the middle area and encased together in a flexible medium to create the appearance of a ribbon, which can be seen as the cable 210.

After the battery 302C is airproofed, the cable 210, which includes the wires 654D_1-654D_9, extends from the battery 202D and can be connected to the connector 208. Corresponding pins of the connector 208 can be connected to the detecting units, e.g., the electric bars 358_1-358_7, and the positive and negative terminals 204 and 206 via the corresponding wires 654D_1-654D_9 in the cable 210, as shown in FIG. 2D.

In alternative embodiments, the circuitry 600C and 600D can be modified to match the circuitry board 400E, 400F and 400G that are placed on the battery 302D, 302F and 302G respectively. The wires are arranged in a similar way as described above.

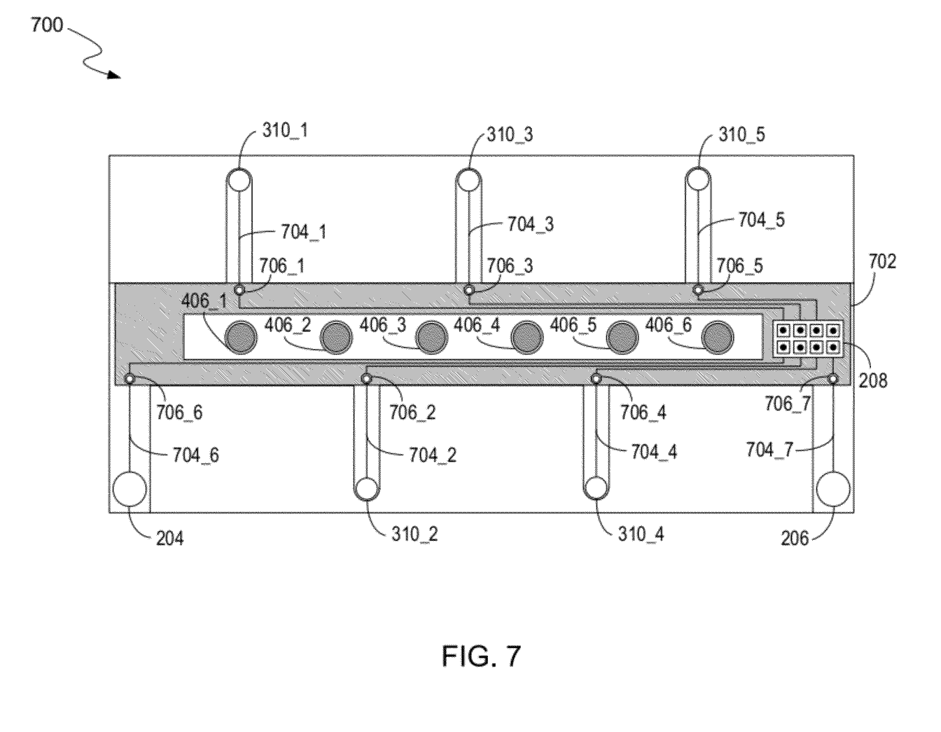

FIG. 7 illustrates a diagram of circuitry located on a circuitry board 700, in accordance with another embodiment of the present invention. FIG. 7 is described in combination with FIG. 2A, FIG. 3A, FIG. 4A and FIG. 4B.

As shown in the example of FIG. 7, the circuitry board 700 has a similar structure as the circuitry board 400A in FIG. 4A and/or FIG. 4B. As such, when the circuitry board 700 is mounted on the battery 302A, the electric sticks 310_1-310_5 and the positive and negative terminals 204 and 206 can protrude through the circuitry board 700 via corresponding holes. Additionally, electrolyte liquid can be infused into the battery cells 304_1-304_6 via corresponding holes 406_1-406_6.

However, compared with the circuitry board 400A, a board 702, e.g., PCB (printed circuit board), is fixed on the middle area of the circuitry board 700 except in the areas where the holes 406_1-406_6 are located. A shaded area shown in FIG. 7 represents the PCB 702 on the circuitry board 700. The connector 208 is mounted on the PCB 702, in one embodiment. Furthermore, welding holes 706_1-706_7 through the PCB 702 are formed (e.g., drilled) in the PCB 702. The welding holes 706_1-706_7 are located near the channels corresponding to the electric sticks 310_1-310_5 and the positive and negative terminals 204 and 206. On the PCB 702, the welding holes 706_1-706_7 are connected to the corresponding pins of the connector 208 via conductive pathways, tracks or signal traces etched from copper sheets laminated onto a non-conductive substrate.

After the circuitry board 700 is placed on the battery 302A, the electric sticks 310_1-310_5 and the positive and negative terminals 204 and 206 can be connected to the associated welding holes 706_1-706_7 by wires 704_1-704_7. As described above, the welding holes 706_1-706_7 are connected to the corresponding pins of the connector 208 via conductive pathways, tracks or signal traces on the PCB 702. The electric sticks 310_1-310_5 function as the detecting units to detect the status of the inner battery cells 304_1-304_6, and the positive and negative terminals 204 and 206 represent the positive and negative terminals of the battery 302A. The detecting units, e.g., the electric sticks 310_1-310_5, and the positive and negative terminals 204 and 206 can be connected to the corresponding pins of the connector 208.

After connecting the detecting units, e.g., the electric sticks 310_1-310_5, and the positive and negative terminals 204 and 206 to the corresponding pins of the connector 208 via the wires 704_1-704_7, the battery 302A is airproofed by a cover board. All the elements can be hidden by the cover board except the positive and negative terminals 204 and 206 of the battery 302A as well as the connector 208, as shown in FIG. 2A.

Additionally, other detecting units, e.g., one or more thermistors, can be embedded inside the battery 302A to detect the status of the inner battery cells 304_1-304_6, e.g., to detect the temperatures of the battery cells 304_1-304_6. Corresponding pins of the connector 208 can be connected to those embedded detecting units to receive the output of those detecting units. Similarly, circuitry for connecting those detecting units to the corresponding pins of the connector 208 is arranged in the battery 302A before the battery 302A is airproofed and is thus hidden after the battery 302A is airproofed.

In an alternative embodiment, a battery management unit can be also configured on the PCB 702. The detecting units, e.g., the electric sticks 310_1-310_5, and the positive and negative terminals 204 and 206 are coupled to the battery management unit for outputting detecting results indicating a status of the inner battery cells in the battery 302A to the battery management unit. Based on the detecting results, the battery management unit can monitor the status of the inner battery cells 304_1-304_6 as well as the battery 202A.

Furthermore, the battery management unit communicates with an outside device via multiple interfaces, e.g., a connector with multiple pins, regarding the status of the inner battery cells 304_1-304_6 to perform predefined operations to prevent the inner battery cells 304_1-304_6 and the battery 202A from being damaged. The battery management unit and related circuitry can be also enveloped in the battery after the battery is airproofed.

In alternative embodiments, the circuitry board 700 can be modified to match the circuitry board 400C, 400E, 400F and 400G that are placed on the battery 302C, 302D, 302F and 302G respectively. The welding holes are formed and the wires are arranged in the similar way as described above.

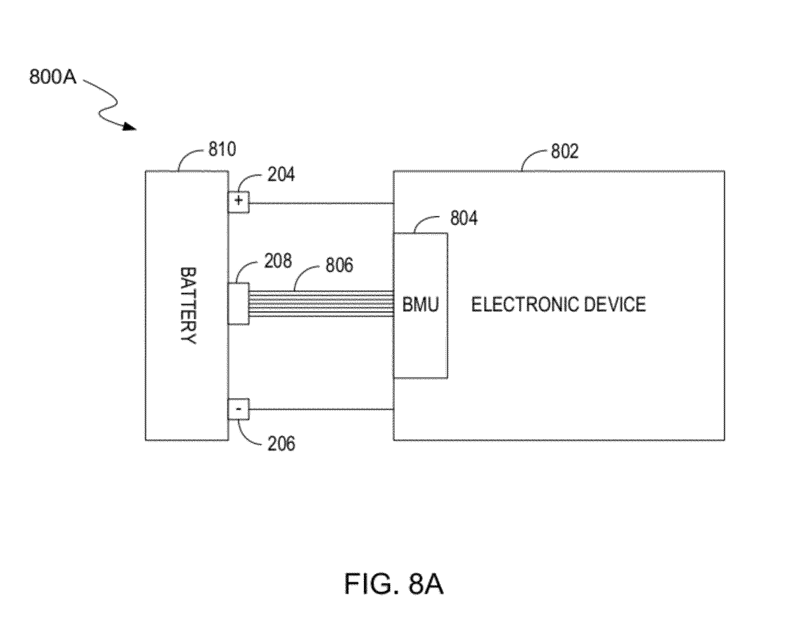

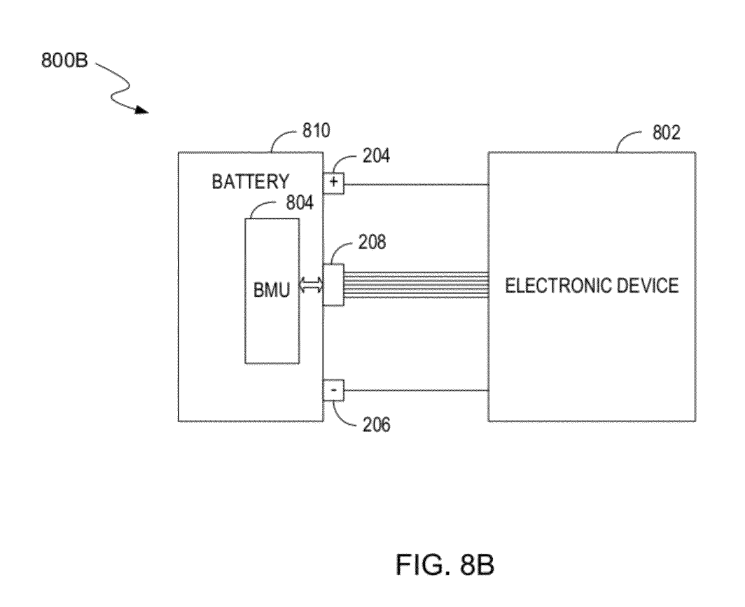

FIG. 8A illustrates a block diagram of an application system 800A including a battery 810 with embedded detecting units, e.g., the battery 202A in FIG. 2A, the battery 202B in FIG. 2B, the battery 202C in FIG. 2C, or the battery 202D in FIG. 2D, in accordance with one embodiment of the present invention. FIG. 8A is described in combination with FIG. 2A, FIG. 2B, FIG. 2C, FIG. 2D, FIG. 3A, FIG. 3C, FIG. 3D, FIG. 3F, and FIG. 3G.

In the application system 800A, the battery 810 is coupled to an electronic device 802 and provides power to the electronic device 802. Furthermore, a battery management unit (BMU) 804 is coupled to the connector 208 for monitoring the status of the inner battery cells (e.g., 304_1-304_6 or 354_1-354_8) as well as the battery 810 and for performing predefined operations to prevent the inner battery cells and the battery 810 from being damaged.

More specifically, the BMU 804 is coupled to the pins of the connector 208 via a cable 806. As such, the BMU 804 can monitor the status of the inner battery cells via the corresponding pins of the connector 208, which are connected to the detecting units (e.g., the electric sticks 310_1-310_5, the electric bars 358_1-358_7, or the electric bars 358_1A-358_7A and 358_1B-358_7B) embedded in the battery 810. In one embodiment, the BMU 804 can monitor the voltages across the inner battery cells by calculating voltage differences between the positive and negative voltages of the inner battery cells as measured by the detecting units. If the BMU 804 detects that a voltage across one of the inner battery cells is higher than a predetermined threshold, the BMU 804 can determine that an abnormal condition is present in that battery cell. As such, the BMU 804 can perform protecting operations to prevent the battery cell from being damaged.

Furthermore, the BMU 804 can also monitor the status of the battery 810 via the corresponding pins of the connector 208 that are connected to the positive and negative terminals 204 and 206. In one embodiment, the BMU 804 can monitor the voltage across the battery 810 by calculating a voltage difference between the positive and negative voltages of the battery 810 at the positive and negative terminals 204 and 206. If the BMU 804 detects that the voltage across the battery 810 is higher than a predetermined threshold, the BMU 804 can determine that an abnormal condition is present in the battery 810. As such, the BMU 804 can perform protecting operations to prevent the battery 810 from being damaged.

The BMU 804 can be incorporated in the electronic device 802, in one embodiment. However, in other embodiments, the BMU 804 is also situated outside the electronic device 802 but in communication with the electronic device 802.

Additionally, if the connector 208 is connected to the battery 810 via the cable 210, the connector 208 can be put anywhere in the application system 800A. The BMU 804 is connected to the connector 208 of the battery 810 via a cable and functions in a similar way as described above.

In an alternative embodiment of an application system 800B shown in FIG. 8B, the battery management unit 804 can be also configured and enveloped inside a battery 810, e.g., the battery 202A, 202B, 202C or 202D, to manage the inner battery cells and communicate with the electronic device 802 via the connector 208. For example, the battery management unit 804 can be configured on the circuitry board 400A, 400C, 400E, 400F, 400G, or 700. As presented above, the battery management unit 804 can receive detecting results indicating the status of the inner battery cells and the battery 810 from the embedded detecting units (e.g., the electric sticks 310_1-310_5, the electric bars 358_1-358_7, or the electric bars 358_1A-358_7A and 358_1B-358_7B) and the positive and negative terminals 204 and 206, and monitor the status of the inner battery cells as well as the battery based on the detecting results. The battery management unit 804 communicates with the electronic device 802 regarding the status of the inner battery cells via multiple pins of the connector 208 to perform predefined operations to prevent the inner battery cells and the battery 810 from being damaged.

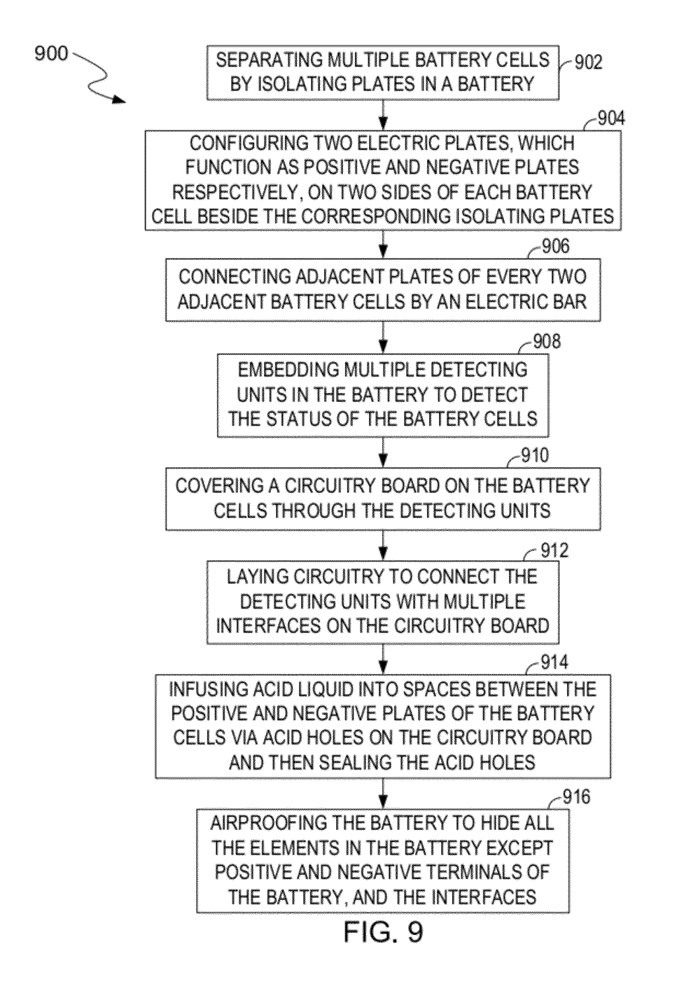

FIG. 9 illustrates a flowchart 900 of a method for fabricating a battery, e.g., the battery 202A in FIG. 2A, the battery 202B in FIG. 2B, the battery 202C in FIG. 2C, or the battery 202D in FIG. 2D, in accordance with one embodiment of the present invention.

In block 902, multiple battery cells can be separated by isolating plates in a battery. In block 904, two electric plates, which function as positive and negative plates respectively, can be installed on two sides of each battery cell next to the corresponding isolating plates. In block 906, an electric bar, e.g., a lead bar, can be coupled between adjacent plates of every two adjacent battery cells to couple the battery cells in series. In block 908, multiple detecting units can be embedded in the battery to detect the status of the battery cells. In one embodiment, an electric bar detects the status of the corresponding battery cells, e.g., to detect the positive and negative voltages and the temperatures of the battery cells. In another embodiment, an electric stick can be embedded into each electric bar to detect the status of the corresponding battery cells.

In block 910, a circuitry board is placed on the battery. In block 912, circuitry to connect the detecting units with multiple interfaces can be located on the circuitry board and then connected to the detecting units. In block 914, electrolyte liquid is infused into spaces between the positive and negative plates of the battery cells via holes on the circuitry board and then the holes can be sealed. In block 916, the battery is airproofed to envelop all the elements in the battery except the positive and negative terminals of the battery and the interfaces.

Accordingly, embodiments in accordance with the present invention provide a battery with embedded detecting units. Advantageously, the status of the inner battery cells in the battery can be detected by the embedded detecting units and the detecting results can be output via multiple interfaces. Thus, there is no need to drill additional holes in the battery to detect the status of the inner battery cells. As such, integrity of the battery can be maintained and the battery is protected against impurities. Furthermore, since an extra element is not added on the surface of the battery, the size and shape of the battery is similar to that of conventional batteries. Thus, the battery can be used in a conventional application system without changes to the application system including the mounting fixture used in the application system.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A battery for supplying power, comprising:
a plurality of battery cells separated by isolating plates;
a plurality of detecting units coupled to said battery cells and operable for detecting a status of said battery cells; and
a plurality of interfaces coupled to said detecting units and operable for receiving detecting results indicating said status from said detecting units,
wherein said battery cells and said detecting units are enveloped inside said battery after said battery is airproofed.

2. The battery of claim 1, further comprising a circuitry board coupled to said battery cells via said detecting units, wherein circuitry for coupling said interfaces to said detecting units is located on said circuitry board, and wherein said circuitry board is enveloped inside said battery after said battery is airproofed.

3. The battery of claim 2, wherein said circuitry board has holes formed therein through which electrolyte liquid is infused into said battery cells after said circuitry board is placed on said battery cells, and wherein said holes are sealed after said electrolyte liquid is infused.

4. The battery of claim 1, further comprising interfaces coupled to positive and negative terminals of said battery and operable for receiving status information of said battery from said positive and negative terminals.

5. The battery of claim 1, further comprising a plurality of electric bars, each of said electric bars coupled between adjacent battery cells and coupling said battery cells in series.

6. The battery of claim 5, wherein said electric bars have a predetermined height respectively and detect voltages of said battery cells.

7. The battery of claim 5, wherein said detecting units comprise a plurality of electric sticks embedded into said electric bars to detect voltages across said battery cells.

8. The battery of claim 1, wherein said interfaces comprise a connector comprising a plurality of pins, wherein said pins are coupled to said detecting units to receive said detecting results.

9. The battery of claim 1, wherein said detecting units comprise at least one thermistor for detecting temperatures of said battery cells.

10. The battery of claim 1, wherein a battery management unit receives said detecting results from said interfaces and performs predefined operations according to said detecting results.

11. A method for fabricating a battery, comprising:
separating a plurality of battery cells using isolating plates in said battery;
embedding a plurality of detecting units in said battery to detect a status of said battery cells;
outputting detecting results indicating said status of said battery cells from said detecting units via a plurality of interfaces coupled to said detecting units; and
airproofing said battery to envelop said battery cells and said detecting units inside said battery.

12. The method of claim 11, further comprising:
mounting a circuitry board on said battery cells through said detecting units;
laying circuitry to couple said interfaces to said detecting units on said circuitry board; and
enveloping said circuitry board inside said battery by airproofing said battery.

13. The method of claim 12, further comprising:
infusing electrolyte liquid into said battery cells via holes on said circuitry board after said circuitry board is placed on said battery cells; and
sealing said holes after said electrolyte liquid is infused.

14. The method of claim 11, further comprising outputting status information for said battery via interfaces coupled to positive and negative terminals of said battery.

15. The method of claim 11, further comprising connecting an electric bar between adjacent battery cells of said battery cells to couple said adjacent battery cells in series.

16. The method of claim 15, wherein said electric bars have a predetermined height respectively and detect voltages of said battery cells.

17. The method of claim 15, wherein said embedding further comprises embedding an electric stick in said electric bar to detect voltage information of said adjacent battery cells.

18. The method of claim 11, wherein said outputting further comprises outputting said detecting results from said detecting units via a plurality of pins of a connector.

19. The method of claim 11, wherein said embedding further comprises embedding at least one thermistor in said battery to detect temperatures of said battery cells.

20. A battery system, comprising:
a plurality of battery cells separated by isolating plates;
a plurality of detecting units coupled to said battery cells and operable for detecting a status of said battery cells; and
a battery management unit coupled to said detecting units and operable for receiving detecting results indicating said status from said detecting units and for performing predefined operations according to said detecting results,
wherein said battery management unit communicates with an outside device via a plurality of interfaces, and wherein said battery cells, said detecting units and said battery management unit are enveloped inside said battery after said battery is airproofed.

21. The battery system of claim 20, further comprising:
a circuitry board mounted on said battery cells and coupled to said detecting units, wherein circuitry for coupling said battery management unit to said detecting units and coupling said battery management unit to said interfaces is located on said circuitry board, and said circuitry board is enveloped inside said battery after said battery is airproofed.

22. The battery system of claim 21, wherein said circuitry board has holes formed therein through which electrolyte liquid is infused into said battery cells after said circuitry board is placed on said battery cells, and wherein said holes are sealed after said electrolyte liquid is infused.

23. The battery system of claim 20, further comprising a plurality of electric bars, each of said electric bars coupled between adjacent battery cells to couple said battery cells in series.

24. The battery system of claim 23, wherein said electric bars have a predetermined height respectively and detect voltages across said batter cells.

25. The battery system of claim 23, wherein said detecting units comprise a plurality of electric sticks embedded into said electric bars to detect voltages across said battery cells.

26. The battery system of claim 20, wherein said detecting units comprise at least one thermistor for detecting temperatures of said battery cells.
